(19) United States
(12) Patent Application Publication
(10) Pub. No.: US 2026/0192642 A1
(43) Pub. Date: Jul. 9, 2026

(54) WATERPROOF HARD COVER

(71) Applicant: WENZHOU TIANMAO AUTOMOBILE PARTS CO., LTD, WENZHOU (CN)

(72) Inventor: Lanhua CAI, WENZHOU (CN)

(21) Appl. No.: 18/959,624

(22) Filed: Nov. 26, 2024

(51) Int. Cl. B60J 7/14; B60J 10/86

(52) U.S. Cl. CPC B60J 7/141; B60J 10/86

(57) ABSTRACT

The present invention discloses a waterproof hard cover that comprises a front bar, a first rotating shaft, a second rotating shaft, a rear bar, a side rail system, a large plate fixing system, a wrench fixing system, and a plurality of plate bodies; the large plate fixing system and the wrench fixing system are connected to the plate body; the first rotating shaft comprises a first rotating shaft left rod, a first rotating shaft intermediate rod and a first rotating shaft right rod, the first rotating shaft left rod is provided with a first rotating shaft left rod concave surface, the first rotating shaft intermediate rod is provided with a first rotating shaft intermediate rod C-groove, the first rotating shaft intermediate rod C-groove mates with the first rotating shaft left rod concave surface.

### FIELD

This invention is relevant to pickup rear cover, especially a waterproof hard cover.

### BACKGROUND

Pickup truck is an essential type of automobile market, pickup truck is a vehicle with sedan front end and cab with open van compartment, which is characterized by both sedan-like comfort and strong power, moreover, it has better cargo capacity and adaptability to bad road surface than sedan. Currently the most common pickup truck models are two-row pickup truck, pickup trucks can be used as a special vehicle, multi-use vehicles, government vehicles and commercial vehicles, it can also be used as a family car, used for cargo, travel and rental and other uses. The so-called “pickup truck” is a hybrid of cars and trucks, with the expansion of the scale of modification enthusiasts, pickup truck modification is becoming more and more modification enthusiasts keen on the category.

Existing pickup truck covers on the market are categorized into soft and hard covers. In the case of hard covers, it is common to connect multiple panels through a system of rotating shafts, which makes them prone to leakage at the rotating shaft connection.

### SUMMARY

In order to solve the above problems of the existing technology, the technical solution adopted in the invention is as follows:

A waterproof hard cover comprises a front bar, a first rotating shaft, a second rotating shaft, a rear bar, a side rail system, a large plate fixing system, a wrench fixing system and a plurality of plate bodies;

The front bar, the first rotating shaft, the second rotating shaft and the rear bar forming a transverse frame, the side rail system forming a longitudinal frame, the transverse frame and the longitudinal frame forming a cover skeleton, the plate bodies are connected to the cover skeleton, the large plate fixing system and the wrench fixing system are connected to the plate bodies;

The first rotating shaft comprises a first rotating shaft left rod, a first rotating shaft intermediate rod and a first rotating shaft right rod, the first rotating shaft left rod is provided with a first rotating shaft left rod concave surface, the first rotating shaft intermediate rod is provided with a first rotating shaft intermediate rod C-groove, the first rotating shaft intermediate rod C-groove mates with the concave surface of the first rotating shaft left rod;

The first rotating shaft is connected with an intermediate rotating shaft waterproof rubber strip, the intermediate rotating shaft waterproof rubber strip comprises an intermediate rotating shaft waterproof rubber strip extrusion protrusion, an intermediate rotating shaft waterproof rubber strip connecting neck and an intermediate rotating shaft waterproof rubber insertion strip, the intermediate rotating shaft waterproof adhesive strip waterproof extrusion protrusion is connected to the intermediate rotating shaft waterproof rubber insertion strip through the intermediate rotating shaft waterproof rubber strip connecting neck; the intermediate rotating shaft waterproof rubber insertion strip clamps with the intermediate rod of the first rotating shaft in a C-shaped groove, the intermediate rotating shaft waterproof rubber strip waterproof extrusion protrusion abuts with the first rotating shaft left rod concave surface.

A waterproof hard cover comprises a front bar, a first rotating shaft, a second rotating shaft, a rear bar, a side rail system, a large plate fixing system, a wrench fixing system and a plurality of plate bodies;

The front bar, the first rotating shaft, the second rotating shaft and the rear bar forming a transverse frame, the side rail system forming a longitudinal frame, the transverse frame and the longitudinal frame forming a cover skeleton, the plate bodies are connected to the cover skeleton, the large plate fixing system and the wrench fixing system are connected to the plate bodies;

The first rotating shaft comprises a first rotating shaft left rod, a first rotating shaft intermediate rod and a first rotating shaft right rod, the first rotating shaft left rod is provided with a first rotating shaft left rod concave surface, the first rotating shaft intermediate rod is provided with a first rotating shaft intermediate rod C-groove, the first rotating shaft intermediate rod C-groove mates with the first rotating shaft left rod concave surface;

The first rotating shaft is connected with an Intermediate rotating shaft waterproof rubber strip, the Intermediate rotating shaft waterproof rubber strip is bonded with the first rotating shaft intermediate rod C-groove, the Intermediate rotating shaft waterproof rubber strip comprises an Intermediate rotating shaft waterproof rubber strip waterproofing extrusion protrusion, the Intermediate rotating shaft waterproof rubber strip waterproofing extrusion protrusion abuts the first rotating shaft left rod concave surface.

Further, the side rail system comprises a side rail and a rubber strip, the side rail is provided in a side rail notch, the rubber strip is provided with a rubber insertion strip, a rubber strip dual protrusion and a semi-circular hollow structure, the rubber insertion strip is clamped with the side rail notch, the rubber strip dual protrusion is tightly affixed to the cargo hopper.

Further, the second rotating shaft is connected to a webbing fixing block, the webbing fixing block comprises a fixing block screw hole and a fixing block protrusion surface, the fixing block screw hole is used for fixing the webbing fixing block, a fixing block lower slot is formed between the fixing block protrusion surface and the second rotating shaft, the fixing block lower slot is used for passing through and tying the webbing.

Further, the front bar buckle comprises a bayonet, a vertical panel, a buckle beveled surface, a buckle vertical surface, a screw fixing hole and a buckle reinforcing bar;

The front bar buckle is connected to the front bar through the screw fixing holes, the vertical panel is vertically connected to the front bar, the bayonet is used for connecting the plug, the buckle beveled surface and the buckle vertical surface are set along the front bar, the buckle reinforcing bar is used for adding to the strength of the buckle.

The beneficial effect of the present invention is that the present invention improves the waterproof effect and avoids water leakage at the rotating shaft by improving the rotating shaft on the car cover and setting a rubber strip at the connection of the rotating shaft.

### BRIEF DESCRIPTION OF THE DRAWINGS

FIG. 1 is a usage schematic diagram I of the present invention.

FIG. 2 is a usage schematic diagram II of the present invention.

FIG. 3 is a structural schematic diagram I of the present invention.

FIG. 4 is a sectional view in the direction of A-A in FIG. 3.

FIG. 5 is a partially enlarged view of part B in FIG. 4 I.

FIG. 6 is a schematic diagram of embodiment 2 of the present invention.

FIG. 7 is a structural schematic diagram II of the present invention.

FIG. 8 is a partially enlarged view of part C in FIG. 7.

FIG. 9 shows a structural schematic diagram III of the present invention.

FIG. 10 is a partially enlarged view of part D in FIG. 9.

FIG. 11 is a usage schematic diagram III of the present invention.

FIG. 12 is a partially enlarged view of part E in FIG. 11.

FIG. 13 is a usage schematic diagram IV of the present invention.

FIG. 14 is a partially enlarged view of part F in FIG. 13.

FIG. 15 is a structural schematic diagram IV of the present invention.

FIG. 16 is a partially enlarged view of part G in FIG. 15.

Figures: 1 - Front bar; 2 - First rotating shaft; 201 - First rotating shaft left rod; 2011 - First rotating shaft left rod blocking hook; 2012 - First rotating shaft left rod concave surface; 201A1 - First rotating shaft left rod round hook; 201A2 - First rotating shaft left rod concave surface; 202 - First rotating shaft intermediate rod; 2021 - First rotating shaft intermediate rod round hook; 2022 - First rotating shaft intermediate rod water outlet; 2021A -First rotating shaft intermediate rod blocking hook; 2022A-first rotating shaft intermediate rod water outlet; 2023A- First rotating shaft intermediate rod C-groove; 2023- First rotating shaft intermediate rod C-groove; 203- First rotating shaft right rod; 204- First rotating shaft left rod joint; 205- First rotating shaft intermediate joint; 206- First rotating shaft right joint; 207- First rotating shaft intermediate rod right joint spacer; 2071-first rotating shaft right rod right joint spacer water outlet notch; 2072- First rotating shaft intermediate rod right joint spacer concave; 208- First rotating shaft intermediate rod right joint spacer; 2081- First rotating shaft intermediate rod intermediate joint spacer convex; 209- First rotating shaft left rod joint spacer; 3- Second rotating shaft; 310- Webbing fixing block; 3101- Fixing block screw hole; 3102- fixing block lower slot; 3103-Fixing block protrusion surface; 311-Intermediate rotating shaft waterproof rubber strip; 3111-Intermediate rotating shaft waterproof rubber strip extrusion protrusion; 3112-Intermediate rotating shaft waterproof rubber strip connecting neck; 3113-Intermediate rotating shaft waterproof rubber insertion strip; 311A-Intermediate rotating shaft waterproof rubber strip; 311A1-Intermediate rotating shaft waterproof rubber strip extrusion protrusion; 4-Rear bar; 5- Side rail system ; 501- Side rail; 5011- Side rail notch; 502- Rubber strip; 5021- rubber insertion strip; 5022- Rubber strip dual protrusion; 5023- Semi-circular hollow structure; 6- Large plate fixing system; 7- Wrench fixing system; 701- Slider; 7011- Vertical notch; 7012- Bulge; 7013- Transverse channel; 7014- Side protrusion; 7015- Semi-circular channel ; 702-T-bar; 8- Plate body; 101- Front bar clamp; 1011- Notch; 1012- Vertical panel; 1014- Buckle beveled surface; 1015- Buckle vertical surface; 1016- Screw fixing hole; 1017- Buckle reinforcing bar.

### DETAILED DESCRIPTION OF THE DISCLOSURE

The following instruction further explains the invention's concrete implementation method.

In order to enable a clearer understanding of the objects mentioned above, features and advantages of the present invention, the invention is described in detail below in connecting with the accompanying FIGURE and specific embodiments. It should be noted that the embodiments of the present invention and the features in the embodiments can be combined without conflict.

The terms "first", "second", "third", etc. are only used to differentiate the description and should not be construed as indicating or implying relative importance.

In the description of the invention, it should also be noted that, unless otherwise expressly specified and limited, the terms "arranged," "installed," "connected," and "combined" should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying FIGURE. It should be understood that the specific embodiments described herein are intended only to illustrate and explain the present invention and not to limit it.

### Embodiment 1

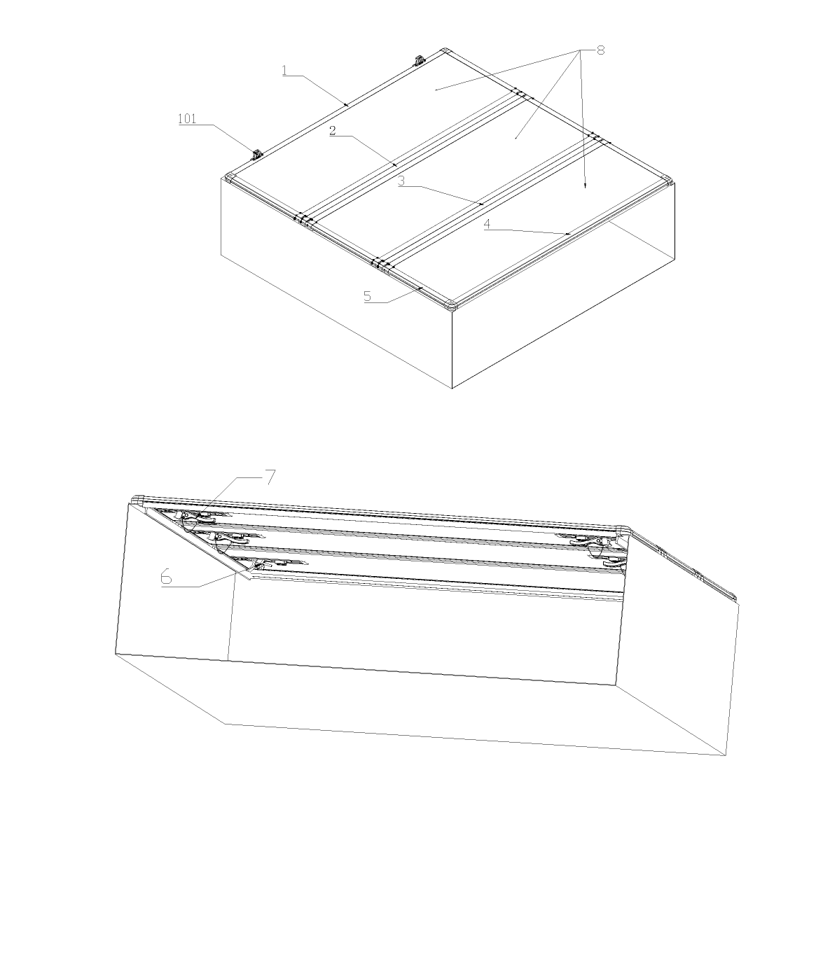

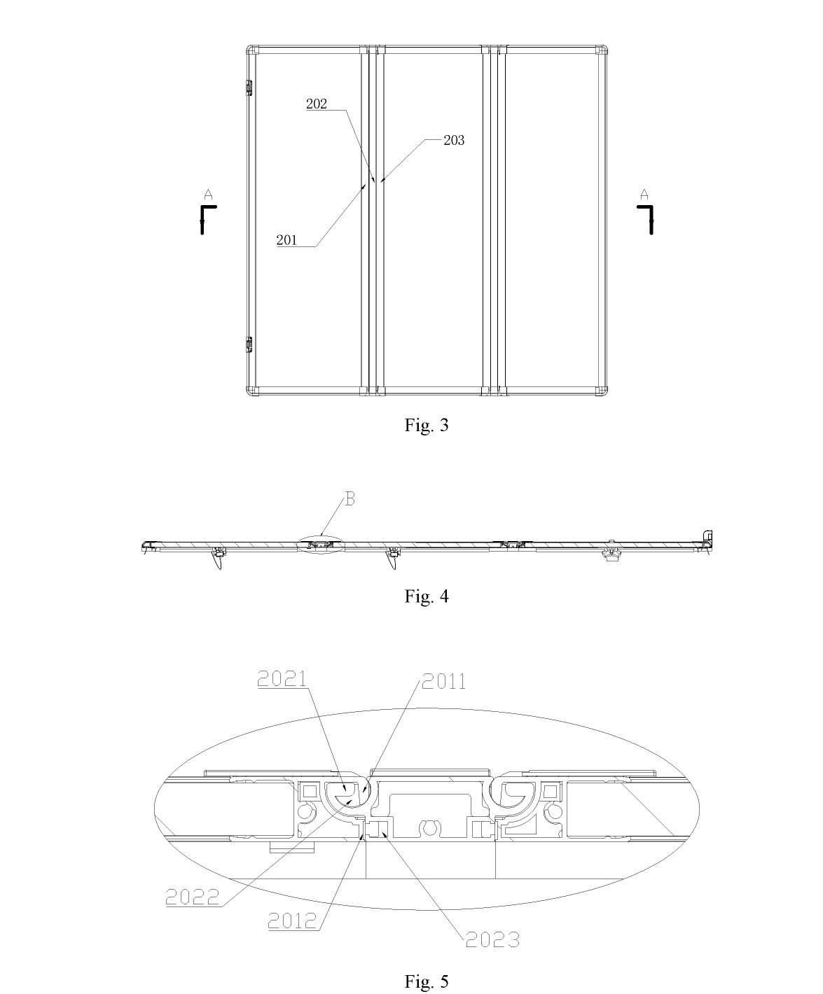

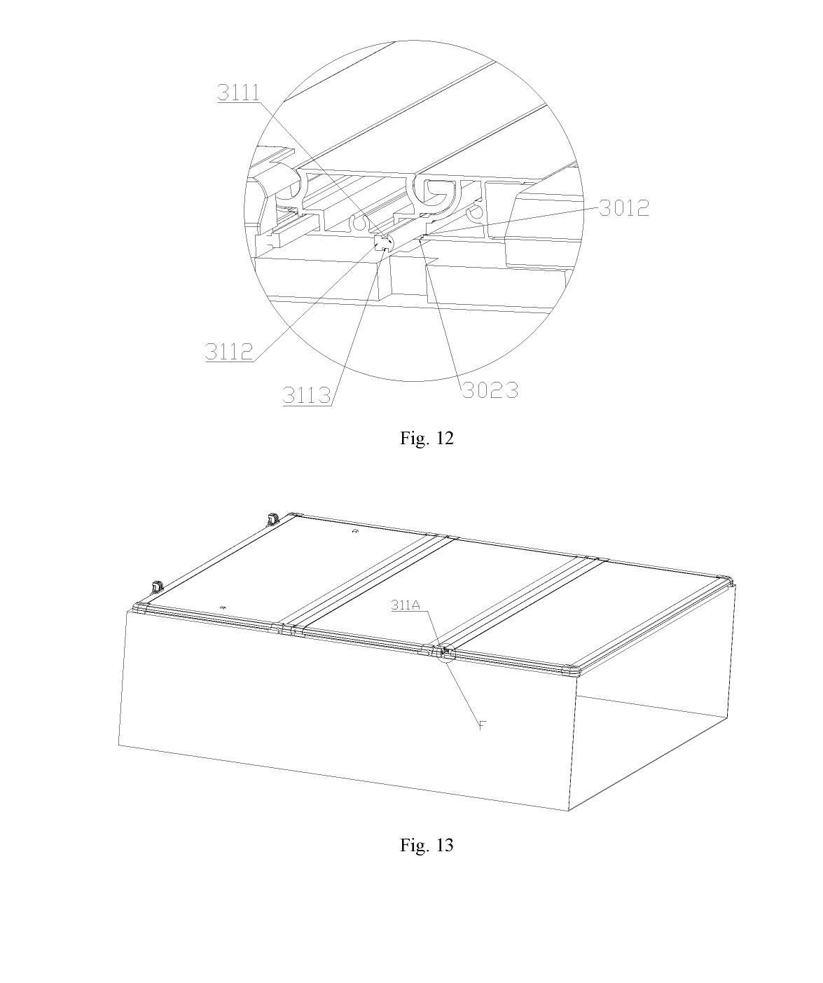

As shown in FIGS. 1-5, 9-12, a waterproof hard cover comprises a front bar 1, a first rotating shaft 2, a second rotating shaft 3, a rear bar 4, a side rail system 5, a large plate fixing system 6, a wrench fixing system 7 and a plurality of plate bodies 8;

The front bar 1, the first rotating shaft 2, the second rotating shaft 3 and the rear bar 4 forming a transverse frame, the side rail system 5 forming a longitudinal frame, the transverse frame and the longitudinal frame forming a cover skeleton, the plate bodies 8 are connected to the cover skeleton, the large plate fixing system 6 and the wrench fixing system 7 are connected to the plate bodies 8;

The first rotating shaft 2 comprises a first rotating shaft left rod 201, a first rotating shaft intermediate rod 202 and a first rotating shaft right rod 203, the first rotating shaft left rod 201 is provided with a first rotating shaft left rod concave surface 2012, the first rotating shaft intermediate rod 202 is provided with a first rotating shaft intermediate rod C-groove 2023, the first rotating shaft intermediate rod C-groove 2023 mates with the first rotating shaft left rod concave surface 2012;

The first rotating shaft 2 is connected with an intermediate rotating shaft waterproof rubber strip 311, the intermediate rotating shaft waterproof rubber strip 311 comprising an intermediate rotating shaft waterproof rubber strip extrusion protrusion 3111, an intermediate rotating shaft waterproof rubber strip connecting neck 3112 and an intermediate rotating shaft waterproof rubber insertion strip 3113, the intermediate rotating shaft waterproof rubber strip extrusion protrusion 3111 and the intermediate rotating shaft waterproof rubber insertion strip 3113 are connected through the intermediate rotating shaft waterproof rubber strip connecting neck 3112; the intermediate rotating shaft waterproof rubber insertion strip 3113 clamps with the first rotating shaft intermediate rod C-groove 2023, the intermediate rotating shaft waterproof rubber strip waterproof extruded bulge 3111 abuts against the first rotating shaft left rod concave surface 2012.

### Embodiment 2

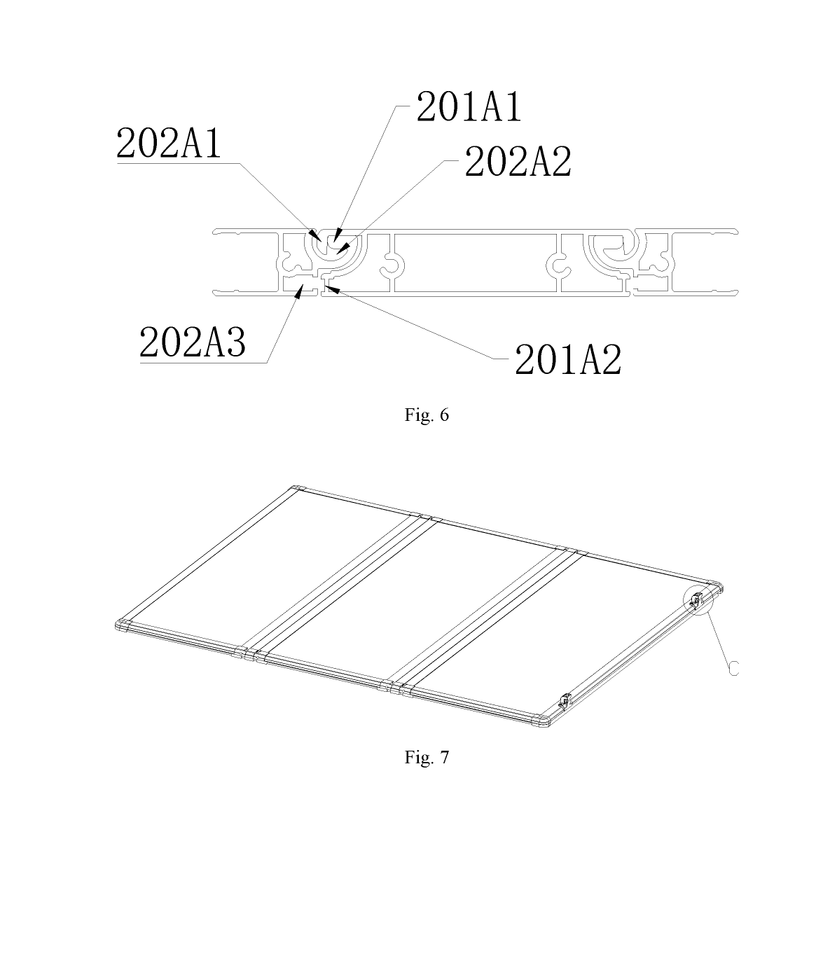

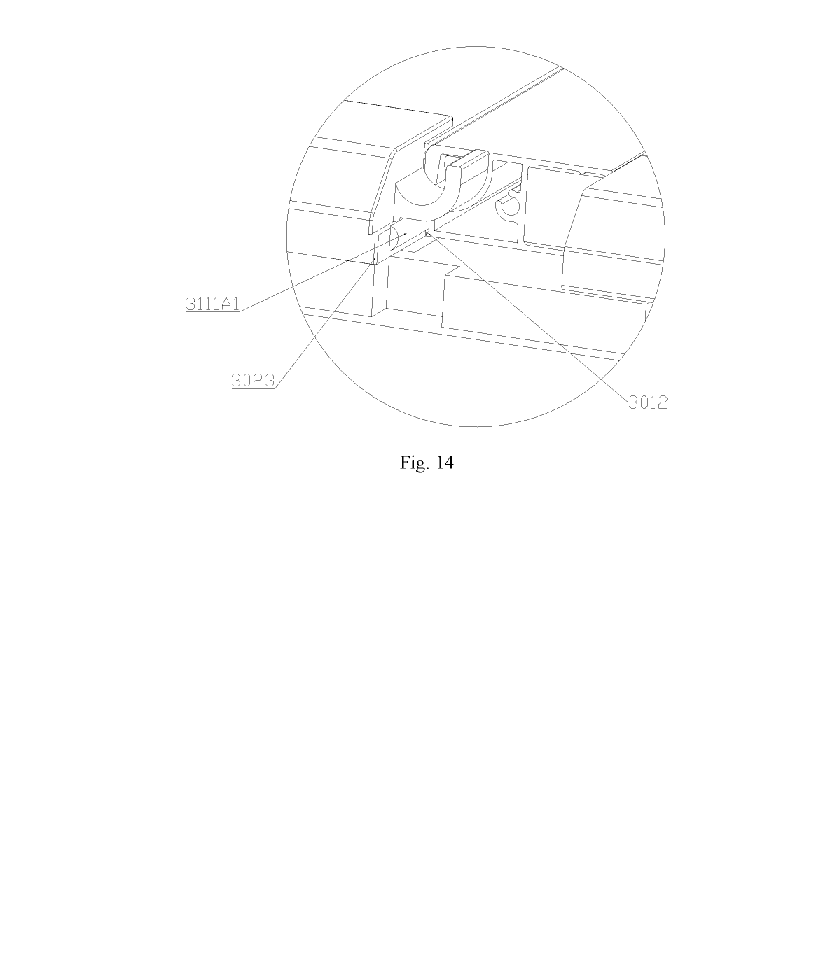

As shown in FIGS. 1-4, 6, 9-14, a waterproof hard cover comprises a front bar 1, a first rotating shaft 2, a second rotating shaft 3, a rear bar 4, a side rail system 5, a large plate fixing system 6, a wrench fixing system 7 and a plurality of plate bodies 8;

The front bar 1, the first rotating shaft 2, the second rotating shaft 3 and the rear bar 4 forming a transverse frame, the side rail system 5 forming a longitudinal frame, the transverse frame and the longitudinal frame forming a cover skeleton, the plate bodies 8 are connected to the cover skeleton, the large plate fixing system 6 and the wrench fixing system 7 are connected to the plate bodies 8;

The first rotating shaft 2 comprises a first rotating shaft left rod 201, a first rotating shaft intermediate rod 202 and a first rotating shaft right rod 203, the first rotating shaft left rod 201 is provided with a first rotating shaft left rod concave surface 2012, the first rotating shaft intermediate rod 202 is provided with a first rotating shaft intermediate rod C-groove 2023A, the first rotating shaft intermediate rod C-groove 2023A mates with the first rotating shaft left rod concave surface 2012;

The first rotating shaft 2 is connected with an intermediate shaft waterproofing rubber strip 311A, the intermediate shaft waterproofing rubber strip 311A is bonded with the first rotating shaft intermediate rod C-groove 2023A, the intermediate shaft waterproofing rubber strip 311A comprises an intermediate shaft waterproofing rubber strip extrusion protrusion 311A1, the intermediate shaft waterproofing rubber strip extrusion protrusion 311A1 abuts the first rotating shaft left rod concave surface 2012.

### Embodiment 3

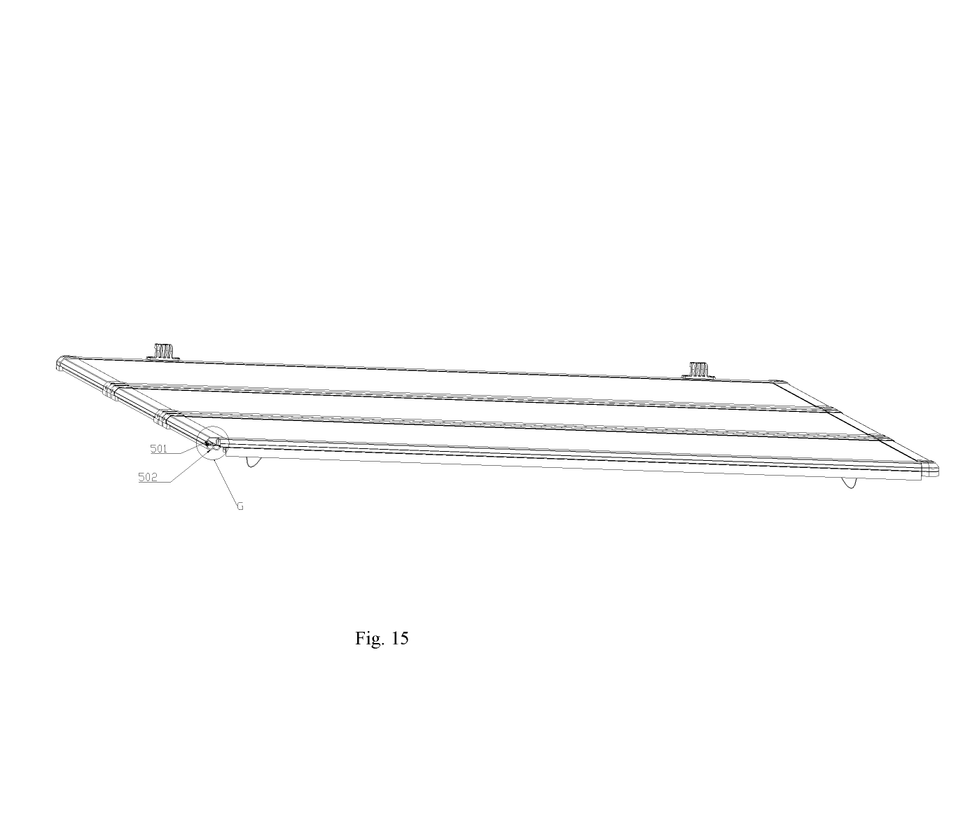

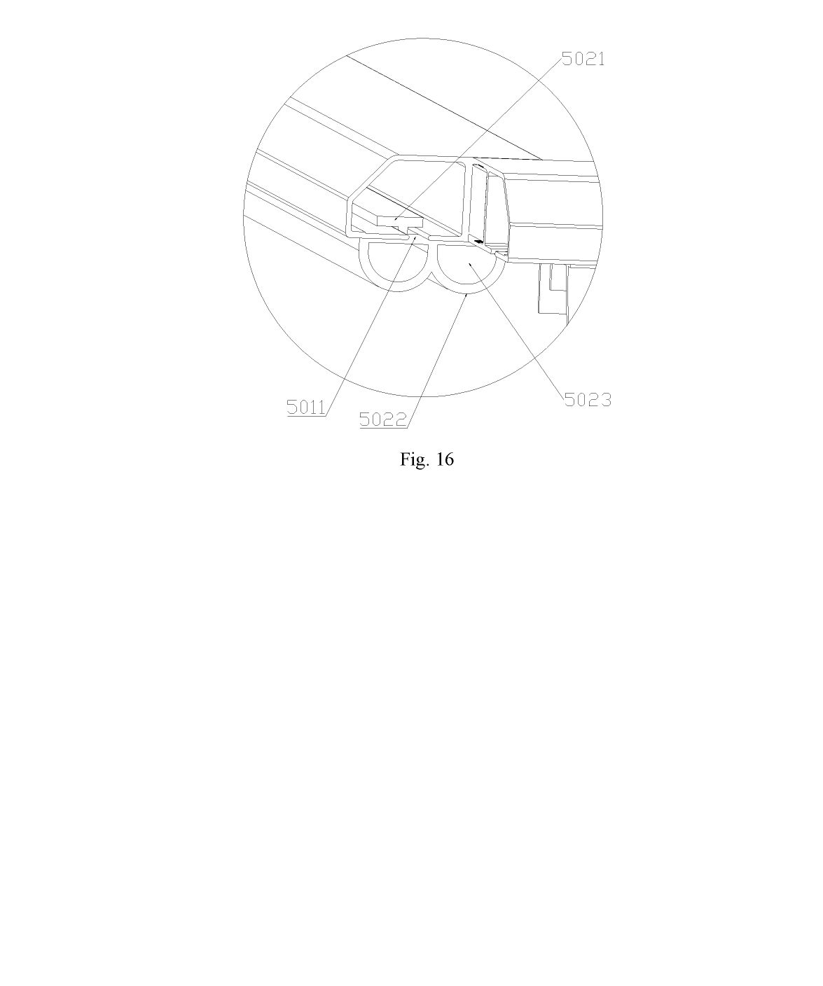

On the basis of embodiments 1 and 2, as shown in FIGS. 15 and 16, the side rail system 5 comprises a side rail 501 and an rubber strip 502, the side rail 501 is provided with a side rail notch 5011, the rubber strip 502 is provided with a rubber insertion strip 5021, a rubber strip dual protrusion 5022 and a semi-circular hollow structure 5023, the rubber insertion strip 5021 is clamped with the side rail notch 5011, the rubber strip dual protrusion 5022 is tightly affixed to the cargo hopper.

### Embodiment 4

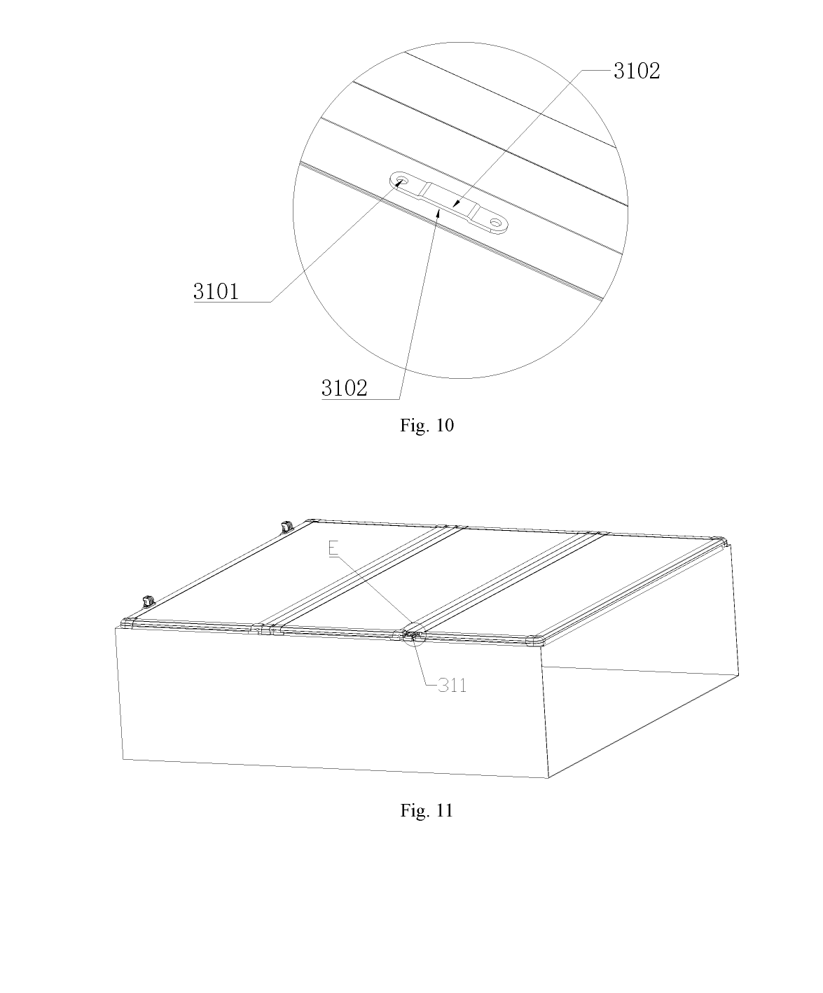

On the basis of embodiments 1 and 2, as shown in FIGS. 9 and 10, the second rotating shaft 3 is further connected with a webbing fixing block 310, the webbing fixing block 310 comprises a fixing block screw hole 3101 and a fixing block protrusion surface 3103, the fixing block screw hole 3101 is used for fixing the webbing fixing block 310, a fixing block lower slot 3102 is formed between the fixing block protrusion surface 3103 and the second rotating shaft 3, the fixing block lower slot 3102 is used for passing through and tying the webbing.

### Embodiment 5

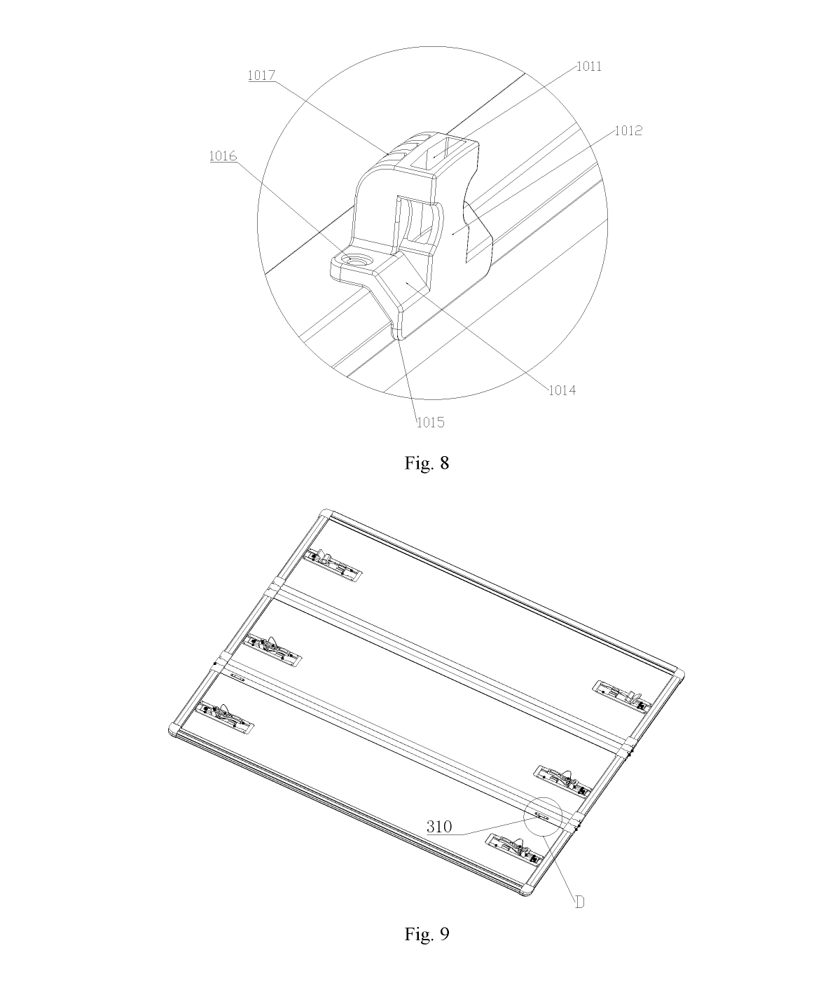

On the basis of embodiments 1 and 2, as shown in FIGS. 7 and 8, the front bar buckle 101 comprises a bayonet 1011, a vertical panel 1012, a buckle beveled surface 1014, a buckle vertical surface 1015, a screw-fixing hole 1016, and a buckle reinforcing bar 1017;

The front bar buckle 101 is connected to the front bar 1 through the screw fixing hole 1016, the vertical panel 1012 is vertically connected to the front bar 1, the bayonet 1011 is used for connecting a plug, the buckle beveled surface 1014 and the buckle vertical surface 1015 are set along the front bar 1, the buckle reinforcing bar 1017 is used for adding the strength of the buckle.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

What is claimed is:

1. A waterproof hard cover comprising a front bar, a first rotating shaft, a second rotating shaft, a rear bar, a side rail system, a large plate fixing system, a wrench fixing system, and a plurality of plate bodies, wherein
the front bar, the first rotating shaft, the second rotating shaft and the rear bar forming a transversal frame, the side rail system forming a longitudinal frame, the transversal frame and longitudinal frame forming a cover skeleton, the plate bodies are connected to the skeleton, the large plate fixing system and the wrench fixing system are connected to the plate bodies;
the first rotating shaft comprises a first rotating shaft left rod, a first rotating shaft intermediate rod and a first rotating shaft right rod, the first rotating shaft left rod is provided with a first rotating shaft left rod concave surface, the first rotating shaft intermediate rod is provided with a first rotating shaft intermediate rod C-groove, the first rotating shaft intermediate rod C-groove mates with the first rotating shaft left rod concave surface; and
the first rotating shaft is connected with an intermediate rotating shaft waterproof rubber strip, the intermediate rotating shaft waterproof rubber strip comprises an intermediate rotating shaft waterproof rubber strip extrusion protrusion, an intermediate rotating shaft waterproof rubber strip connecting neck and an intermediate rotating shaft waterproof rubber insertion strip, the intermediate rotating shaft waterproof rubber strip waterproof extrusion protrusion is connected to the intermediate rotating shaft waterproof rubber insertion strip through the intermediate rotating shaft waterproof rubber strip connecting neck; the intermediate rotating shaft waterproof rubber insertion strip clamps with the first rotating shaft intermediate rod C-groove, the intermediate rotating shaft waterproof rubber strip waterproof extrusion protrusion abuts with the first rotating shaft left rod concave surface.

2. A waterproof hard cover comprising a front bar, a first rotating shaft, a second rotating shaft, a rear bar, a side rail system, a large plate fixing system, a wrench fixing system, and a plurality of plate bodies, wherein
the front bar, the first rotating shaft, the second rotating shaft and the rear bar forming a transversal frame, the side rail system forming a longitudinal frame, the transversal frame and the longitudinal frame forming a cover skeleton, the plate bodies are connected to the cover skeleton, the large plate fixing system and the wrench fixing system are connected to the plate bodies;
the first rotating shaft comprises a first rotating shaft left rod, a first rotating shaft intermediate rod and a first rotating shaft right rod, the first rotating shaft left rod is provided with a first rotating shaft left rod concave surface, the first rotating shaft intermediate rod is provided with a first rotating shaft intermediate rod C-groove), the first rotating shaft intermediate rod C-groove mates with the first rotating shaft left rod concave surface; and
the first rotating shaft is connected with an intermediate shaft waterproof rubber strip, the intermediate shaft waterproof rubber strip is bonded with the first rotating shaft intermediate rod C-groove, the intermediate shaft waterproof rubber strip comprises an intermediate shaft waterproof rubber strip waterproof extruded protrusion, the intermediate shaft waterproof rubber strip waterproof extruded protrusion abuts with the first rotating shaft left rod concave surface.

3. The waterproof hard cover according to claim 1, wherein the side rail system comprises a side rail and a rubber strip, the side rail is provided with a side rail notch, the rubber strip is provided with a rubber insertion strip, a rubber strip dual protrusion and a semi-circular hollow structure, the rubber insertion strip is clamped with the side rail notch, the rubber strip dual protrusion is tightly affixed to the cargo hopper.

4. The waterproof hard cover according to claim 1, wherein the second rotating shaft is connected with a webbing fixing block, the webbing fixing block comprises a fixing block screw hole and a fixing block protrusion surface, the fixing block screw hole is used for fixing the webbing fixing block, a fixing block lower slot is formed between the fixing block protrusion surface and the second rotating shaft, the fixing block lower slot is used for passing through and tying the webbing.

5. The waterproof hard cover according to claim 1, wherein the front bar comprises a front bar buckle, and the front bar buckle comprises a bayonet, a vertical panel, a buckle beveled surface, a buckle vertical surface, a screw fixing hole, and a buckle reinforcing bar; and
the front bar buckle is connected to the front bar through the screw fixing hole, the vertical panel is vertically connected to the front bar, the bayonet is used for connecting the plug, the buckle beveled surface and the buckle vertical surface are set along the front bar, the buckle reinforcing bar is used for adding the strength of the buckle.

6. The waterproof hard cover according to claim 2, wherein the side rail system comprises a side rail and a rubber strip, the side rail is provided with a side rail notch, the rubber strip is provided with a rubber insertion strip, a rubber strip dual protrusion and a semi-circular hollow structure, the rubber insertion strip is clamped with the side rail notch, the rubber strip dual protrusion is tightly affixed to the cargo hopper.

7. The waterproof hard cover according to claim 2, wherein the second rotating shaft is connected with a webbing fixing block, the webbing fixing block comprises a fixing block screw hole and a fixing block protrusion surface, the fixing block screw hole is used for fixing the webbing fixing block, a fixing block lower slot is formed between the fixing block protrusion surface and the second rotating shaft, the fixing block lower slot is used for passing through and tying the webbing.

8. The waterproof hard cover according to claim 2, wherein the front bar comprises a front bar buckle, and the front bar buckle comprises a bayonet, a vertical panel, a buckle beveled surface, a buckle vertical surface, a screw fixing hole, and a buckle reinforcing bar; and
the front bar buckle is connected to the front bar through the screw fixing hole, the vertical panel is vertically connected to the front bar, the bayonet is used for connecting the plug, the buckle beveled surface and the buckle vertical surface are set along the front bar, the buckle reinforcing bar is used for adding the strength of the buckle.
